(19) United States
(12) Patent Application Publication
(10) Pub. No.: US 2010/0171317 A1
(43) Pub. Date: Jul. 8, 2010

(54) CONNECTION ASSEMBLY FOR COMPONENTS OF A WIND TURBINE

(75) Inventor: Alf Trede, Immenstedt (DE)

Correspondence Address: RANKIN, HILL & CLARK LLP, 38210 Glenn Avenue, WILLOUGHBY, OH, 44094-7808, US

(73) Assignee: REPOWER SYSTEMS AG, Hamburg (DE)

(21) Appl. No.: 12/593,198

(22) PCT Filed: Mar. 6, 2008
(86) PCT No.: PCT/EP2008/001793

§ 371 Date: Feb. 17, 2010

(30) Foreign Application Priority Data
Mar. 26, 2007 (DE) 10 2007 014 861.7

(51) Int. Cl. F03D 1/00; E04B 1/62; E04B 1/21; E04B 1/38

(52) U.S. Cl. 290/55; 52/515; 52/655.1; 52/704; 52/745.21

(57) ABSTRACT

A connection of components (11, 12, 13) of a wind turbine (WEA), especially of components (11, 12, 13) of a wind turbine (WEA) with a diameter greater than 0.5 m, preferably greater than 1.0 m, more preferably greater than 1.5 m, in which two components (11, 12, 13) to be connected to each other each have contact areas facing toward each other, and in the connected state the components (11, 12, 13) are or become secured to each other. The connection is constituted by multiple intermediate connecting bodies (20) arranged between a first component (11; 12) of the wind turbine (WEA) and a second component (12; 13) of the wind turbine (WEA) and by designing the intermediate connecting bodies (20) with contact areas which are arranged opposite to the contact areas of the first and second component (11, 12, 13), at least one contact area of the intermediate connecting bodies (20) being provided with a coating.

### BACKGROUND OF THE INVENTION

1. Field of the Invention

The invention concerns a connection of components of a wind turbine, especially of components of a wind turbine with a diameter greater than 0.5 m, preferably greater than 1.0 m, more preferably greater than 1.5 m, in which two components to be connected to each other each have contact areas facing toward each other, and in the connected state, the components are or become secured to each other.

Moreover, the invention concerns a use or arrangement of intermediate connecting bodies for a connection of components of a wind turbine, a method for creating a connection of components of a wind turbine and a wind turbine.

2. Description of Related Art

In the state of the art, for example, a wind turbine of the patent applicant is known under the designation “5M”, which has a rated power of 5 megawatts (MW).

To connect large volume components of a wind turbine with each other during installation, maintenance or repair, flange connections and/or screw connections are provided between the components. Such components which are connected to one another are, for example, the rotor shaft and gearbox input as well as the rotor hub and the rotor shaft.

In addition to that, screw connections are used with the connection of the tubular tower with the pivot bearing as well as that of the machine support of a wind turbine with the further components of a wind turbine, in particular the connection to the rotor bearing, the gearbox mounting, the axle trunnion and the (ring) generator.

### BRIEF SUMMARY OF THE INVENTION

Based on this state of the art, it is the object of the present invention to improve the connection of large volume components of a wind turbine, whereby it should be possible to increase the load-bearing capacity of screw connections or the like, which are subject to high stress.

The object is solved by a connection of components of a wind turbine, in particular components of a wind turbine with a diameter greater than 0.5 m, preferably greater than 1.0 m, more preferably greater than 1.5 m, in which components to be connected to each other each have contact areas facing toward each other, and in the connected state, the components are or become secured to each other, the connection is further constituted in that multiple intermediate connecting bodies are or will be arranged between a first component of the wind turbine and a second component of the wind turbine and that the intermediate connecting bodies are designed with contact areas which are arranged opposite to the contact areas of the first and second component and that on a contact area of the intermediate connecting bodies a coating is provided, where the at least one coated contact area of the intermediate connecting body has the effect of increasing the coefficient of friction when the connection is formed.

The fact that intermediate bodies with a coating which increases the coefficient of friction are placed or fitted between the contact areas of components achieves a non-permanent connection of mechanically highly stressed components or components for a wind turbine. Appropriate connection components and/or screws or the like are used to create or develop an initial stress between the two components to connect or which are connected, so that a force-fit connection is achieved. In the process, the friction-enhancing coating between the two components is microplastically deformed by the initial stress applied via the connection components, which achieves higher coefficients of friction. This is particularly important in the utilization or construction of wind turbines, because, for example, the wind turbines are built or repaired under very adverse conditions for assembly and repair.

With the inventive assembly, it is possible to connect components to each other which have weights of tons, which are in some cases dirty or oily, at heights of up to 120 m. even under adverse weather conditions, such as snow, ice or rain, with a mechanically highly stressed connection between the components, where at the same time the arrangement of the friction-enhancing intermediate connecting bodies between the contact areas of the components increases or will increase the bearing capacity of the connection.

In the scope of the invention, the term “connection” is particularly understood as a flange connection of components. Furthermore, in the scope of the invention, the term “component” is particularly understood as a functional group or system group or a functional unit or system unit of a wind turbine, such as a rotor hub, rotor shaft, or gear box which is or becomes mechanically coupled with another function/system group or function/system unit of the plant via the inventive connection. In particular, the components or functional units or system units are large-volume components with weights from more than 100 kg up to several tons.

Moreover, the connection is characterized in that the at least one coated contact surface of the intermediate connecting body or bodies has a rougher surface than that of the contact area of the first and/or second component opposite to the coated contact area of the intermediate connecting body or bodies. Due to the harder, friction-enhancing coating of the intermediate connecting bodies compared to the contact areas of the components, the (micro)plastic deformation of the softer contact areas is improved with application of an initial stress through corresponding connection components. In this way, the frictional connection of the components to be connected is increased.

The connection is particularly characterized in that the intermediate connecting bodies are provided in each case with a coating on the contact areas, said coating being situated opposite the contact areas of the first and second component, where the coated contact areas increase the coefficient of friction during the formation of the connection and/or have a rougher surface than the contact areas of one or both components. This creates a non-permanent connection with high coefficients of friction between the intermediate connecting bodies and the contact areas, for which, if during maintenance of the wind turbine or of components of the wind turbine the link between the components with the intermediate connecting bodies arranged between them is disconnected during disassembly, it is ensured to form a connection between the components with a strong friction bond during subsequent reassembly.

In addition to that, it is envisaged in a further embodiment that through or with the arrangement of the intermediate connecting bodies between the first and second component, the friction bond between the first and the second component is or becomes increased, in particular compared to a connection of the first and second component without intermediate connecting bodies situated in between them.

The connection is particularly characterized in that the first and second component are connected to each other by means of a flange connection or flange.

It is advantageous for the first and second component to be subject to an initial stress, preferably by screws, bolts or suchlike, so that a non-positive connection is formed between the components of a wind turbine to be connected.

Furthermore, the intermediate connecting bodies are or will be penetrated by the connection components so that an accurately fitting arrangement of the intermediate connecting bodies is ensured between the components and/or contact surfaces.

In addition to that, it is advantageous if the coating or the coatings of the intermediate connecting bodies contain hard particles, in particular particles with the hardness grade of diamonds or cubic boron-nitrate (CBN) or of corundum or carbide.

Such coatings are characterized in that as friction-enhancing coatings they improve the non-permanent connection between the components.

In an alternative, the coating has zinc silicate or is formed correspondingly by spray plating of zinc or suchlike with a coating which increases coefficients of friction. Spray plating with zinc also provides a reliable coating which increases coefficients of friction.

The connection is particularly characterized in that it has a coefficient of friction greater than 0.5, preferably greater than 0.55, particularly greater than 0.6 or 0.7 due to the inventive coating, so that a compact design of connection flanges on the components is possible because of the high coefficients of friction.

In addition to that, the intermediate connecting bodies are advantageously designed to be plate-shaped or like small blocks, which results in simple handling of the intermediate connecting bodies during installation. The fact that small segments are coated as intermediate connecting bodies makes it possible for small segments to be inexpensively coated or able to be coated. After disassembly or repair of the components, the intermediate components of the non-permanent connection can also be replaced without great effort, which significantly improves the handling of the intermediate connecting bodies.

Furthermore, for example, the contact areas of the first and second component are designed to be ring-like and/or enclosed for the formation of a flange connection.

A particular embodiment of the connection is characterized in that the intermediate connecting bodies form a kind of segmented ring with or through the arrangement between the first and second component, in particular a segmented circular ring, or parts thereof, so that the intermediate connecting bodies are designed as plate-shaped circular ring segments, for example. Here, the intermediate connecting bodies are mechanically connected with the first and/or second component by means of mounting elements, in particular screws, pins or clamps or suchlike or will be connected by means of the mounting components. For example, by means of the mounting elements the segmented intermediate connection bodies are connected with a component so that afterward the second component with a contact area is arranged on the other, free side of the intermediate connection bodies.

In particular, the first component is constructed as a rotor shaft and the second component as a rotor hub or as a gearbox input shaft. In an alternative, the first component is constructed as a tubular tower or as a machine frame and the second component as a pivot bearing which is or will be situated on the tubular tower.

In the scope of the invention, it is also possible that the inventive connection is formed between the machine support of a wind turbine and the rotor bearing, axle trunnion, generator or gearbox mounting.

Advantageously, the connection is formed as a force-fit, in particular non-permanent, connection, in particular a connection subject to shearing force and/or torsional force or a screw connection.

Preferably, the first or second or third component is a cast part, preferably with (connection) diameters of 0.5 m to 1 m.

Moreover, the object is solved by the use or arrangement of intermediate connecting bodies in at least one embodiment of a previously described connection of two components of a wind turbine. To avoid repetition, explicit reference is made to the previous exposition.

A further solution of the object results using a method for producing a connection of components of a wind turbine in which a connection is formed according to one of the exemplary embodiments mentioned above.

In addition to that, the object is solved by a wind turbine which is constructed with a connection described above.

### BRIEF DESCRIPTION OF THE DRAWINGS

The invention is described below, without restricting the general intent of the invention, based on drawings, whereby explicit reference is made to the drawings for all details of the invention that are not explained in greater detail in the text. These show in

FIG. 1 a cross-section view of the connection of a rotor shaft to a rotor hub and the gear box in the section;

FIG. 2 a detail view of the connective transition of the rotor shaft and the gear box;

FIG. 3a a detail view of the flange connection of the rotor hub and rotor shaft;

FIG. 3b the view of a flange connection of the rotor hub with a cut rotor shaft;

FIG. 4a-4d respective views of circular segment intermediate bodies and

FIG. 5 a detail view of a connective transition of the rotor shaft with the gear box according to a further embodiment.

### DETAILED DESCRIPTION OF THE INVENTION

In the figures that follow, in each case the same or similar components or corresponding parts bear the same reference numbers so that a corresponding redundant presentation is avoided.

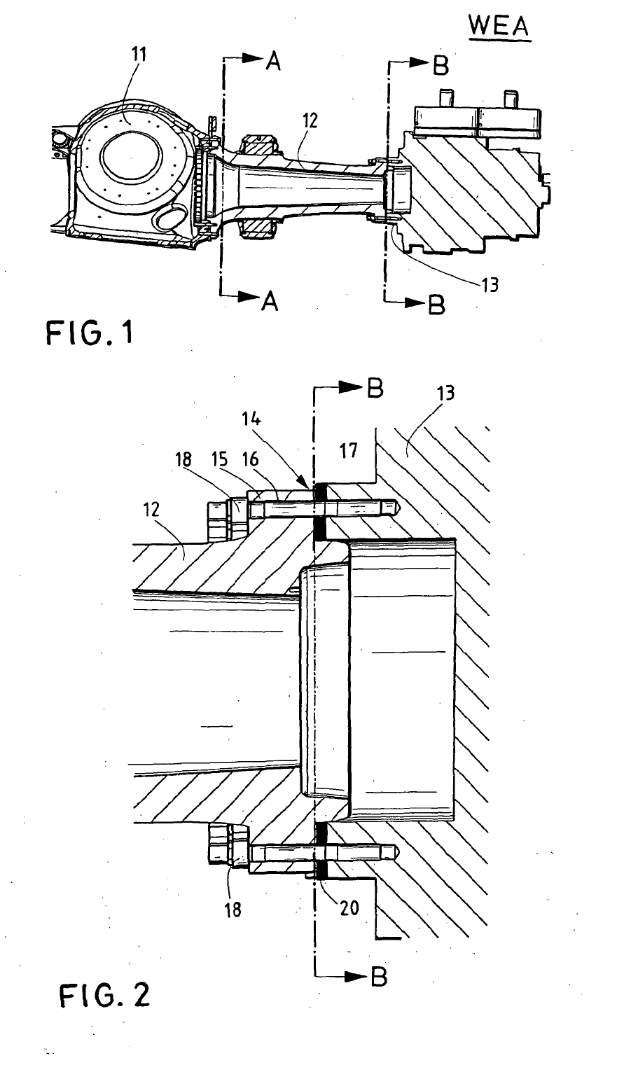

FIG. 1 shows in cross-section the connected arrangement of a rotor hub 11 with a rotor shaft 12 and a connection part 13 of a corresponding gear box of a wind turbine. The rotor hub 11, rotor shaft 12 and gearbox, which has the connection part 13 in the front area and is not shown in greater detail in the cross section, are parts of a schematically characterized wind turbine WEA.

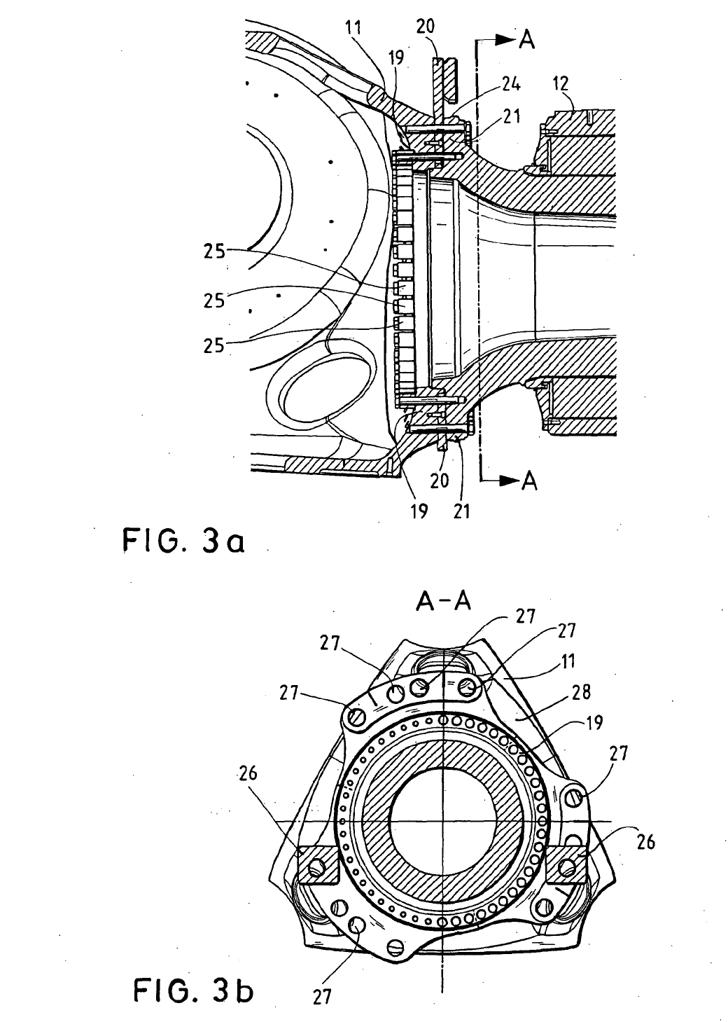

As can be seen from the detail view in FIG. 2, the rotor shaft 12 is connected with the connection part 13 of the gear box by means of a flange connection 14. For this purpose, the rotor shaft 12 has a flange ring 15 on the end facing toward the connection part 13, said ring 15 having corresponding bore holes for accommodating screws. The bore holes 16 are arranged at regular intervals on the circumference of the flange ring 15. The connection part 13 of the gear box has corresponding blind holes 17 on the side facing the rotor shaft 12, said holes 17 having corresponding threads. Screws 18 with threads are inserted in the bore holes 16 of the rotor shaft 12 and bore holes 17 of the connection part 13 so that the rotor shaft 12 becomes connected with the connection part 13 with the formation of an initial stress.

There are intermediate connecting bodies 20 arranged in the area of the bore holes 16, 17 between the end of the rotor shaft 12 and the end of the connection part 13, which is arranged opposite to the rotor shaft 12, said intermediate connecting bodies 20 being situated non-permanently between the rotor shaft 12 and the connection part 13. In accordance with the invention, the intermediate connecting bodies are provided with a friction-enhancing coating on both sides of the rotor shaft 12 and the connection part 13, so that by tightening the screws 18, the coefficient of friction and friction bond between the rotor shaft 12 and the connection part 13 is or becomes increased.

During disassembly, i.e. dismantling the connection between the rotor shaft 12 and the connection part 13 by unscrewing the screws 18, it is possible for the intermediate connecting bodies 20 in the non-permanent connection between the components to be removed manually. The contact areas of the rotor shaft 12 and connection part 13, which are opposite one another, can be either coated or untreated, i.e. smooth.

In particular, the intermediate connecting bodies 20 are provided with a coating of hard particles, such as diamonds, in which the particle size is greater than 30 μm, preferably greater than 35 μm. Preferably, the intermediate connecting bodies are diamond coated with a nickel base by electroplating, with an average particle size of 46 μm (diamond D46). Typically, the ends of the rotor shaft 12 and connection part 13 are greater than 0.5 m in diameter.

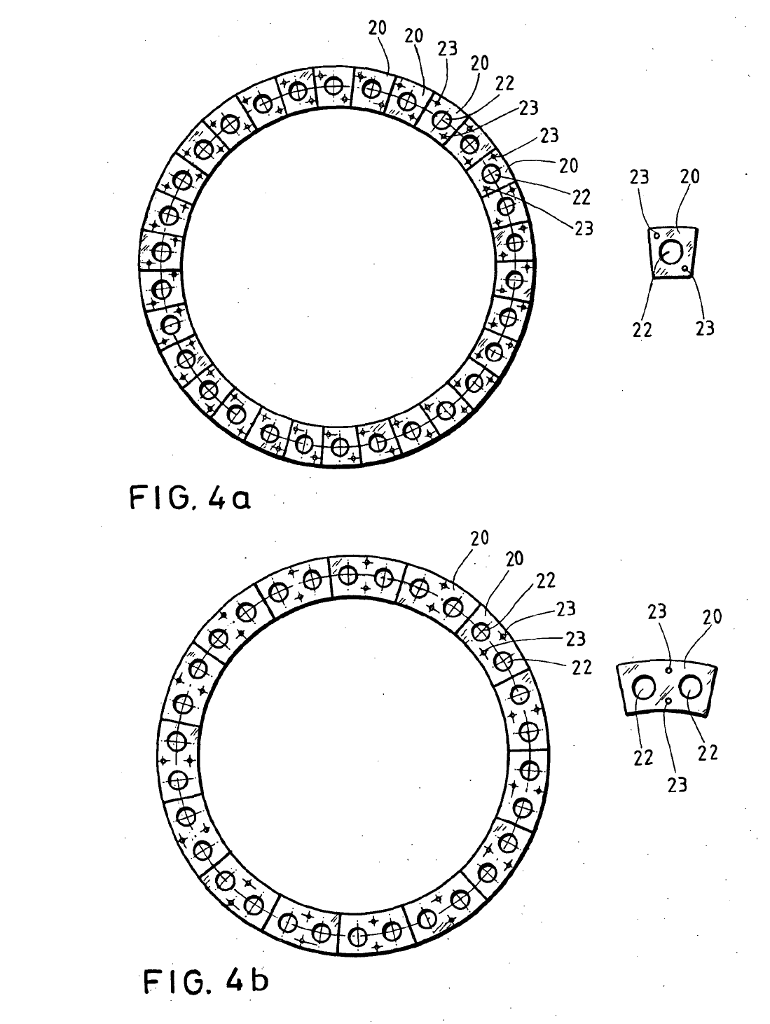

Furthermore, in FIG. 3a a detail view of the connection between the rotor shaft 12 and the rotor hub 11 (compare FIG. 1) is shown in cross section. The rotor hub 11 has a flange ring 19 with corresponding bore holes on its inner side for this purpose, into which bolts or screws are inserted and connected with the face side of the rotor shaft 12. Corresponding blind holes for accommodating screws or bolts are provided on the rotor shaft 12 for this purpose.

The screws or bolts are inserted from the inner side of the rotor hub 11 and connected with the rotor shaft 12. Furthermore, a flange ring 21 with corresponding bore holes for accommodating bolts or screws is provided on the rotor shaft 12 for forming a mutual flange connection. Here the bolts are inserted in the bore holes of the flange ring 21 from the side facing away from the rotor hub 11, so that the bolts or screws penetrate correspondingly formed (blind or through) holes on the rotor hub 11, where the bolts of the outer row of the flange ring 21 are arranged towards the bolts of the inner row of the flange ring 19 of the rotor hub 11. Here, the hole circle of the bore holes of the flange ring 21 is larger than the hole circle of the bore holes of the flange ring 19.

Altogether this enables a double-rowed screw flange connection of the two mechanically highly stressed components, in which the assembly ensues by the rotor hub and rotor shaft being aligned with each other, then the screw connection of the row of bolts on the outer lying flange ring 21 of the rotor shaft 12 is made and after that the connection components in the form of bolts or screws are screwed in the inside of the rotor hub 11 on the inner lying flange ring 19. Then the bolts or screws are subjected to a predetermined pre-load force. This enables a robust flange connection of the rotor hub 11 with the rotor shaft 12.

Sleeves 25 under the screw heads of the inner row of screws make it possible to use uniform length screws for purposes of standardization. A track 24 is situated on the outer flange ring 21 and functions as a contact track for a lightning arrestor (not shown).

In order to form a friction-enhanced connection between the rotor hub 11 and the rotor shaft 12, a row of intermediate connecting bodies 20 is arranged between the two ends of the rotor shaft 12 and the rotor hub 11 or between the flange rings 19 and the flange ring 21, which have coated surfaces toward both contact areas of the flange rings 19, 20, such that the friction bond leads to better friction locking upon tensioning of the row of bolts on the flange rings 19, 21.

As a result of the inventive intermediate connecting bodies 20 with their friction-enhancing coatings toward both sides of the rotor hub 11 and rotor shaft 12 components, an arrangement is achieved for preventing relative motion between the components (rotor hub 11 and rotor shaft 12) which are braced against each other, frictionally engaged and co-acting.

In particular, the rotor hub 11 is a component made of a cast material, such as nodular graphite iron, or made of simple structural steel, where the contact surface of the flange ring 20 for the rotor shaft is preferably mechanically finished to be smooth, for example RZ 16.

In addition to that, the rotor shaft 12 as a second component is executed as a steel component (quenched and tempered steel or heat-treated steel) or as a cast component. Preferably, the contact area for the rotor hub 11 can be sandblasted, for example SA3 processed, whereas in other embodiments the surface can also be hardened.

The initial stress applied between the rotor shaft 12 and the rotor hub 11 via the connection components and/or bolts should achieve surface pressures on the contact areas in the range of 60 to 220 N/mm², preferably between 90 and 200 N/mm². For coatings with zinc, such as spray plating with zinc or zinc silicate, lower surface pressures are preferred, preferably to be established between 20 and 100 N/mm². This enables coefficients of friction for the connection of the rotor shaft with the rotor hub in excess of 0.6, preferably above 0.7, to be achieved in a very cost-effective, reliable way.

Under good conditions, coefficients of friction above 0.85 are achievable; even after slippage a friction coefficient of 0.65 is achieved. This enables connection flanges to be designed compactly. Alternatively, with the same dimensions a simple screw-tightening method (such as a torque-controlled one instead of hydraulic pre-tensioning) can be used.

Furthermore, FIG. 3b shows a view of the flange ring 19 of the rotor hub 11. From this it can be seen that the bore holes of the flange ring 19 are arranged in a circular manner in which the connection area of the rotor hub 11 toward the rotor shaft on the flange ring 19 has a diameter greater than 0.5 m in general.

It is also apparent from FIGS. 3a and 3b that the intermediate connecting bodies 20 are used concurrently as a locking disk for a locking of the rotor. The locking disk consists of three identical segments which are executed as a intermediate connecting body 20. Locking takes place via two locking devices 26 in which bolts (not shown) are pushed through the bolt receptacles 27. A total of 12 bolt receptacles 27 are arranged so that each rotor blade can be locked in a vertical and horizontal position.

The three openings 28 in the locking disk enable maintenance personnel to pass through into the rotor hub encasement. It is particularly economical if the locking disk is manufactured from leftover pieces from the manufacture of the machine frame. The rotor hub encasement (not shown) is preferably attached to the intermediate components 20 in order that the power transmission in the rotor hub not be disrupted by additional attachments (gatings).

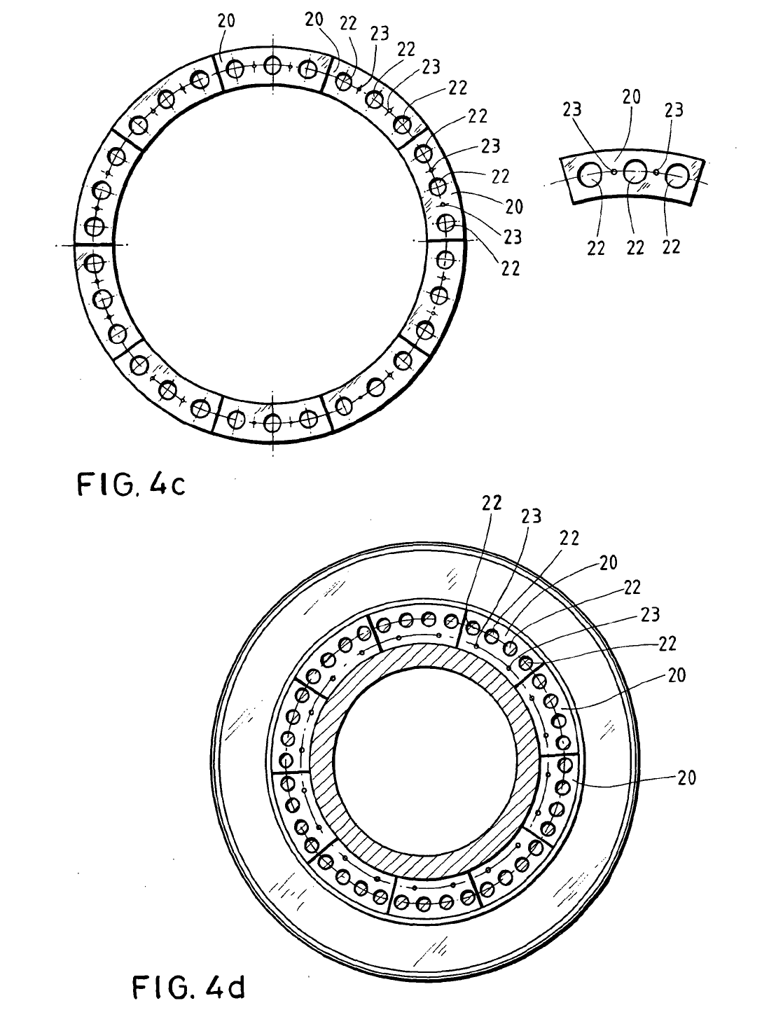

Various embodiments of the arrangement of an intermediate connecting body 20 on an component or on a flange of a component are shown in FIGS. 4a through 4d. The left area of FIGS. 4a through 4c each show a circular arrangement of the intermediate connecting bodies 20, and the right area of the figures shows an individual view of the intermediate connecting bodies 20 in each case.

As an example, the intermediate connecting bodies 20 are 5 mm thick and 200 to 600 mm long. Smaller components reduce the costs of coating, but increase the effort of assembly, so the exact dimensions are to be adapted to the respective preferred as well as the specified application in the individual case.

A type of segmented ring is formed from the intermediate connecting bodies 20 by means of the intermediate connecting bodies 20 coated on one side, preferably coated on both sides toward the contact areas of the components, said intermediate connecting bodies being between the contact areas of two components, in particular the contact areas of a flange connection between the components. The intermediate connecting bodies 20 are designed as a partial segment of a circular arrangement.

The intermediate connecting bodies 20 can have one or more through borings 22 so that the intermediate connecting bodies 20 are penetrated by bolts or screws of a flange connection between two components to be connected. In addition to that, the intermediate connecting bodies 20 have smaller bore holes 23 so that mounting components in the form of countersunk screws penetrate the bore holes 23, which enables or simplifies mounting the intermediate connecting bodies 20 on a flange ring, for example.

This way, the intermediate connecting bodies 20 can be mounted on the contact areas of the components by inserting screws or other mounting components in the bore holes, with the contact areas preferably having corresponding blind holes for accommodating threads.

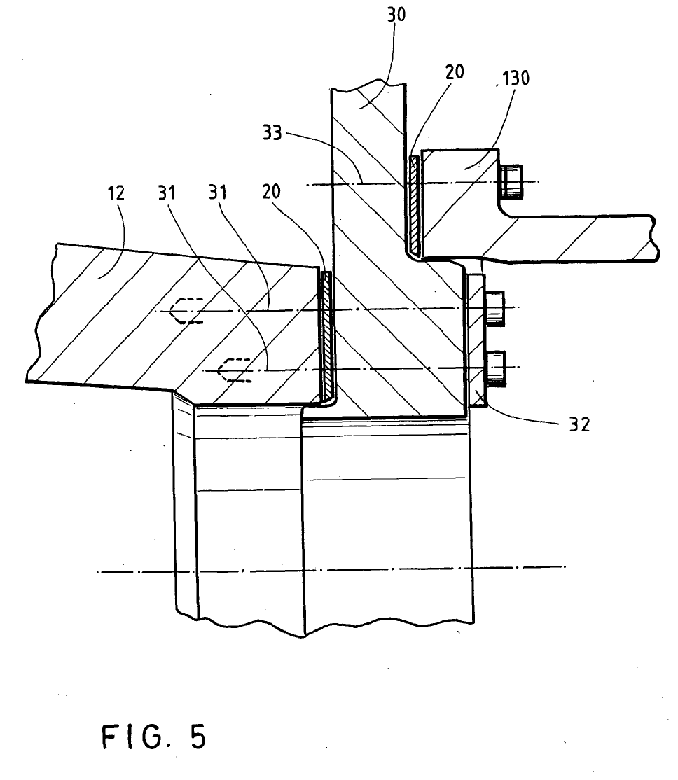

FIG. 5 shows another exemplary embodiment of a connection of a rotor shaft 12 to a gear box flange 130 of a gearbox not shown further, corresponding to the embodiment shown in FIG. 2. Here between the rotor shaft 13 and the gearbox flange 130, a locking disk 30 is situated, which has contact areas toward the rotor shaft 12 and the gearbox flange 130.

In order to improve the strength of the connection between the rotor shaft 12 and the locking disk 30 or between the rotor shaft 12 and the gearbox flange 130, there are intermediate connecting bodies 20 arranged between the rotor shaft 12 and the locking disk 130, which are provided with a coating on the surface. Furthermore, the locking disk 30 is provided with through borings so that schematically drawn screws 31 which are used on the gearbox flange side penetrate a washer 32, the locking disk 30 and the provided through borings of the intermediate connecting bodies 20 and end in blind holes of the rotor shaft 12. A better load distribution is achieved through the washer 32.

Furthermore, between the locking disk 30 and the gearbox flange 130 there are intermediate connecting bodies 20 arranged so that the gearbox flange 130 and the locking disk 30 are connected with schematically drawn screws 33. The intermediate connecting bodies 20 are intermediate connecting bodies 20 which are hardened and/or coated in accordance with the invention, so that improved force-fit connections with higher friction bonds result.

The embodiment shown in FIG. 5 is the multiple combination or a connection in series of multiple connections according to the invention.

### LIST OF REFERENCE NUMBERS

11 Rotor hub
12 Rotor shaft
13 Connection component (gear box)
14 Flange connection
15 Flange ring
16 Bore hole
17 Bore hole
18 Screws
19 Flange ring
20 Intermediate connecting body
21 Flange ring
22 Through boring
23 Bore hole
24 Track
25 Sleeve
26 Locking mechanism
27 Bolt receptacle
28 Opening
29 Locking disk
30 Screws
31 Washer
32 Screws
130 Gearbox flange
WEA Wind turbine

1. A connection of components (11, 12, 13) of a wind turbine (WEA), in particular components (11, 12, 13) of a wind turbine (WEA) with a diameter greater than 0.5 m, comprising:
at least two components (11, 12, 13) to be connected to each other, each having contact areas facing toward each other, and in the connected state the components (11, 12, 13) are or become secured to each other,
wherein multiple intermediate connecting bodies (20) are arranged between a first component (11; 12) of the wind turbine (WEA) and a second component (12; 13) of the wind turbine (WEA) and that the intermediate connecting bodies (20) are designed with contact areas which are arranged opposite to the contact areas of the first and second component (11, 12, 13) and that on at least one contact area of the intermediate connecting bodies (20) a coating is provided, where the at least one coated contact area of the intermediate connecting body (20) has the effect of increasing the coefficient of friction when the connection is formed.

2. The connection according to claim 1, wherein the at least one coated contact area of the intermediate connecting bodies (20) has a rougher surface than that of the contact area of the first and/or second component (11, 12, 13) opposite the coated contact area of the intermediate connecting bodies (20).

3. The connection according to claim 1, wherein the intermediate connecting bodies (20) are provided in each case with a coating on the contact areas, said coating being situated opposite the contact areas of the first and second component (11, 12, 13), where the coated contact areas increase the coefficient of friction during the formation of the connection and/or have a rougher surface than the contact areas of one or both components (11, 12, 13).

4. The connection according to claim 1, wherein through or with the arrangement of the intermediate connecting bodies (20) between the first and second component (11, 12, 13) the friction bond between the first and the second component (11, 12, 13) is or becomes increased, in particular compared to a connection of the first and second component (11, 12, 13) without intermediate connecting bodies (20) situated in between them.

5. The connection according to claim 1, wherein the first and the second component (11, 12, 13) are connected to one another by means of a flange connection or a flange (14, 19, 21).

6. The connection according to claim 1, wherein the first and second component (11, 12, 13) are or become subject to an initial stress by connection components (18).

7. The connection according to claim 6, wherein the intermediate connecting bodies (20) are or become penetrated by the connection components (18).

8. The connection according to claim 1, wherein the coating or coatings of the intermediate connecting bodies (20) have grade of diamonds or cubic boron-nitrate (CBN) or of corundum or carbide.

9. The connection according to claim 1, wherein the coating has zinc silicate or is spray-plated with zinc.

10. The connection according to claim 1, wherein the connection has a coefficient of friction greater than 0.5.

11. The connection according to claim 1, wherein the intermediate connecting bodies (20) are designed to be plate-shaped or like small blocks.

12. The connection according to claim 1, wherein the contact areas of the first and of the second component (11, 12, 13) are formed to be ring-like and/or enclosed.

13. The connection according to claim 1, wherein the intermediate connecting bodies (20) form a kind of segmented ring with or through the arrangement between the first and second component (11, 12, 13).

14. The connection according to claim 1, wherein the intermediate connecting bodies (20) are or become mechanically connected with the first and/or second component (11, 12, 13) by means of mounting components.

15. The connection according to claim 1, wherein the first component (12) is constructed as a rotor shaft and the second component (11, 13) as a rotor hub (11) or as a gearbox input shaft (13).

16. The connection according to claim 1, wherein the first component (11) is constructed as a tubular tower and the second component (12) as a pivot bearing which is or will be situated on the tubular tower.

17. The connection according to claim 1, wherein the connection is formed as a force-fit, in particular non-permanent connection, in particular a connection subject to shearing force and/or torsional force or a screw connection.

18. The connection according to claim 1, wherein the first or second component is a cast component.

19. The use or arrangement of intermediate connecting bodies (20) for at least one connection according to claim 1.

20. A method for producing a connection of components (11, 12, 13) of a wind turbine (WEA), in which a connection is formed according to claim 1.

21. A wind turbine (WEA) with a connection according to claim 1.
